(19) United States
(12) Patent Application Publication
(10) Pub. No.: US 2025/0294524 A1
(43) Pub. Date: Sep. 18, 2025

(54) RESOURCE ALLOCATION WITH SENSING OF LONG TERM EVOLUTION (LTE) AND NEW RADIO (NR) SIDELINK

(71) Applicant: Apple Inc., Cupertino, CA (US)

(72) Inventors: Hong He, San Jose, CA (US); Chunxuan Ye, San Diego, CA (US); Dawei Zhang, Saratoga, CA (US); Wei Zeng, Saratoga, CA (US); Haitong Sun, Saratoga, CA (US); Huaning Niu, San Jose, CA (US); Peng Cheng, Beijing (CN); Weidong Yang, San Diego, CA (US); Zhibin Wu, Los Altos, CA (US); Chunhai Yao, Beijing (CN)

(21) Appl. No.: 18/860,151

(22) PCT Filed: Apr. 29, 2022
(86) PCT No.: PCT/CN2022/090581

§ 371 Date: Oct. 25, 2024

(51) Int. Cl. H04W 72/02; H04W 72/541; H04W 72/563

(52) U.S. Cl. CPC H04W 72/02; H04W 72/541; H04W 72/563

(57) ABSTRACT

A user equipment (UE), including a vehicle to everything (V2X) device, other UE, a baseband processor or other network device can perform sensing of candidate resources on a Long Term Evolution (LTE) sidelink resource pool of an LTE sidelink channel and a new radio (NR) resource pool of an NR sidelink channel for a sidelink (SL) communication on an NR sidelink channel based on sensing results of the sensing of the candidate resources. According to the sensing results, the SL communication can be transmitted on the NR sidelink channel based on LTE candidate resources of the LTE sidelink channel and NR candidate resources of the NR sidelink channel in a co-channel coexistence.

### FIELD

The present disclosure relates to wireless technology including resource selection with sensing for Long Term Evolution (LTE) sidelink and new radio (NR) sidelink.

### BACKGROUND

Mobile communication in the next generation wireless communication system, 5G, or new radio (NR) network will provide ubiquitous connectivity and access to information, as well as ability to share data, around the globe. 5G networks and network slicing will be a unified, service-based framework that will target to meet versatile and sometimes, conflicting performance criteria to provide services to vastly heterogeneous application domains ranging from Enhanced Mobile Broadband (eMBB) to massive Machine-Type Communications (mMTC), Ultra-Reliable Low-Latency Communications (URLLC), and other communications. In general, NR will evolve based on third generation partnership project (3GPP) long term evolution (LTE)-Advanced technology with additional enhanced radio access technologies (RATs) to enable seamless and faster wireless connectivity solutions. Another type of mobile communication includes vehicle communication, where vehicles communicate or exchange vehicle related information. The vehicle communication can include vehicle to everything (V2X), which includes vehicle to vehicle (V2V), vehicle to infrastructure (V2I) and vehicle to pedestrian (V2P) where direct communication without a base station may be employed, such as in a sidelink (SL) communication.

In some situations, vehicle related information is intended for a single vehicle or other entity. In other situations, such as emergency alerts, vehicle related information is intended for a large number of vehicles or other entities. The emergency alerts can include collision warnings, control loss warnings, and the like.

V2X communication and associated applications provide an ever-increasing potential benefit for safety between vehicles and pedestrian devices, which can include one or more of: bicyclist, children being pushed in baby carriages/strollers, walkers, joggers, people embarking on trains and busses, drivers, passengers, or more with a mobile device. V2X communications can ensure that a vehicle with adequate safety components, applications and other devices such as pedestrian user equipment (P-UE) are aware of one another sufficiently to avoid a collision, for example.

### BRIEF DESCRIPTION OF THE DRAWINGS

FIG. 1 illustrates an exemplary block diagram illustrating an example of user equipment(s) (UEs) communicatively coupled a network with network components as peer devices useable in connection with various embodiments (aspects) described herein.

FIG. 2 illustrates a diagram illustrating example components of a device that can be employed in accordance with various aspects discussed herein.

FIG. 3 illustrates an example simplified block diagram of a user equipment (UE) wireless communication device or other network device/component (e.g., eNB, gNB) in accordance with various aspects.

FIG. 4 illustrates an example full sensing and selection window timeline in accordance with various aspects.

FIG. 5 illustrates another example partial sensing and selection window timeline in accordance with various aspects.

FIG. 6 illustrates an example process flow for resource allocation selection according to various aspects.

FIG. 7 illustrates another example process flow of resource allocation selection for co-channel coexistence with LTE SL and NR SL according to various aspects.

FIG. 8 illustrates another example process flow of resource allocation selection for co-channel coexistence with LTE SL and NR SL according to various aspects.

FIG. 9 illustrates another example process flow of resource allocation selection for co-channel coexistence with LTE SL and NR SL according to various aspects.

FIG. 10 illustrates another example process flow of resource allocation selection for co-channel coexistence with LTE SL and NR SL according to various aspects.

FIG. 11 illustrates another example process flow of resource allocation selection for co-channel coexistence with LTE SL and NR SL according to various aspects.

FIG. 12 illustrates another example process flow of resource allocation selection for co-channel coexistence with LTE SL and NR SL according to various aspects.

FIG. 13 illustrates another example process flow of resource allocation selection for co-channel coexistence with LTE SL and NR SL according to various aspects.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Various aspects including a user equipment (UE) device operating in sidelink (SL) communication and selecting resources to enable SL communication are described herein. The UE device can be a pedestrian UE (P-UE) device, a vehicle-to-everything (V2X) device, or other UE that may include vehicle-to-vehicle (V2V), vehicle-to-infrastructure (V2I), vehicle-to-pedestrian (V2P) device communication, or other direct communication between UEs, which can comprise a sidelink (SL) communication; each transmitter and receiver can include a user equipment (UE) device. A UE when referred to herein can include any of these devices and also further include a Roadside Unit (RSU), a drone, other vehicle device, Internet of Things (IoT) device, or other user equipment device, for example.

Power saving, as well as latency, are important considerations when utilizing SL communication, which can be a direct communication between UE terminals (e.g., a transmitter UE and a receiver UE in a unicast transmission). Specifically, because safety-related traffic requires low latency, uplink and downlink communications that pass through a base station may not necessarily meet latency requirements in certain situations (e.g., emergency messaging or other urgencies). Thus, sidelink communication can be configured for direct communication between UEs as autonomous vehicles, pedestrian UEs or the like.

Currently, LTE sidelink (SL) communication and NR SL communication are configured by two different mechanisms with two different SL channels, although some processes are shared, such as autonomous resource allocation for both LTE SL and NR SL. However, LTE SL and NR SL do not necessarily share the same channel, and thus, co-channel coexistence is not configured, either by frequency division multiplexing (FDM) or time division multiplexing (TDM). In particular, for some V2X network configurations (e.g., ITS (intelligent transport system) bandwidth is limited for cellular V2X). Because the SL resources, especially for the ITS band, can be limited, a demand exists for LTE SL and NR SL to share the same resource of both frequency/time resources in a configuration referred to as co-channel coexistence. As such, aspects herein configure and enable NR SL and LTE SL to dynamically share the same time and frequency resources in co-channel coexistence for SL.

Two different types of categories of NR sidelink communication can be implemented based on the resource allocation method configured: mode-1 communication and mode-2 communication. NR Mode-1 communication includes a method where a base station (e.g., gNB or eNB) allocates usable resources for direct communication between terminals (different UEs) and can be used when all terminals that perform sidelink communication are in an in-coverage situation. NR Mode-2 communication is a method where each UE or terminal selects usable resources for direct communication (e.g., SL communication) and can be used even when the terminals are in an out-of-coverage situation. Because the base station does not intervene in resource allocation for mode-2 communication, the UE identifies the usable resources itself.

In LTE SL, mode 4 is similar to NR mode-2 communication, in which the UE senses and selects resources for SL communication without allocation from a base station. Sensing is used for identifying resources that can be used for the sidelink, in order to decode the physical sidelink control channel (PSCCH) during a sensing window of a certain period before performing SL transmission. This enables fair coexistence of the SL channel with other UEs, for example. In response to acquiring the SL channel and selecting resources, the UE can provide sidelink control information (SCI) to a receiver UE; further enabling, the receiver UE to respond on the SL channel.

In an aspect, a UE (e.g., a V2X UE or other UE with processing circuitry and memory) can be configured to perform sensing of candidate resources on an LTE sidelink resource pool associated with an LTE sidelink channel and on an NR resource pool associated with an NR sidelink channel for a sidelink (SL) communication on based on sensing results of the sensing of the candidate resources. The UE can then transmit the SL communication on the sidelink channel (e.g., an NR SL channel) based on selected LTE candidate resources of the LTE sidelink channel and those of the NR candidate resources of the NR sidelink channel in a co-channel coexistence over the sidelink channel. The sensing of the NR sidelink resource pool can be based on sensing results of the LTE sidelink resource pool that overlap in time and frequency with the NR sidelink resource pool. A sidelink resource selection procedure can be performed for NR sidelink data to be transmitted based on a higher priority of the sensing results being associated with the LTE sidelink resource pool. Alternatively, or additionally, the NR sidelink resource pool can have a higher priority than the LTE sidelink resource pool.

Aspects include processes for supporting co-channel coexistence between the LTE sidelink and the NR sidelink (SL). In particular, the NR SL can be in mode-2 SL operation and the LTE SL be in mode-4 operation; thus, NR SL resource allocation by the UE can take into consideration the LTE SL resource reservation. Additionally, or alternatively, the NR SL can be in mode-1 SL operation and the LTE SL be in mode-4 operation; thus, the NR SL UE can report the LTE sensing results to the base station.

In an aspect, the sensing operations performed on candidate resources on the LTE sidelink resource pool of the LTE sidelink channel can be performed during an LTE sensing window and on the NR sidelink resource pool of the NR sidelink channel in co-channel coexistence with the LTE sidelink channel during an NR sensing window. The LTE sensing window can be configured for a full sensing operation or a partial sensing operation in the LTE sidelink channel, and the NR sensing window is configured for the full sensing operation or the partial sensing operation in the NR sidelink channel. When partial sensing is used, the power consumption can be reduced to the extent that the decoding time is reduced. Sensing operations on the LTE resource pool can be based on sensing results of the LTE resource pool, and vice versa, according to aspects herein.

In one example, the UE can perform full sensing operation in the NR sidelink channel during an NR sensing window and in the LTE sidelink channel during an LTE sensing window based on overlapping time and resources between the LTE sidelink resource pool and the NR sidelink resource pool. The NR sensing window can be generated based on an initial NR slot (n) that triggers an NR sidelink resource selection procedure, a sidelink (SL)-sensing window parameter of one or more slots that is preconfigured, and a processing time (T_{proc,0}) of the sensing results, in which n can be an integer. The LTE sensing window can be based on an LTE logical or physical subframe (n′) that corresponds to the initial NR slot (n), a frequency division duplexing (FDD)/time division duplexing configuration parameter, and a predefined positive integer or an in-device coordination time between an LTE sidelink module component and an NR sidelink module component.

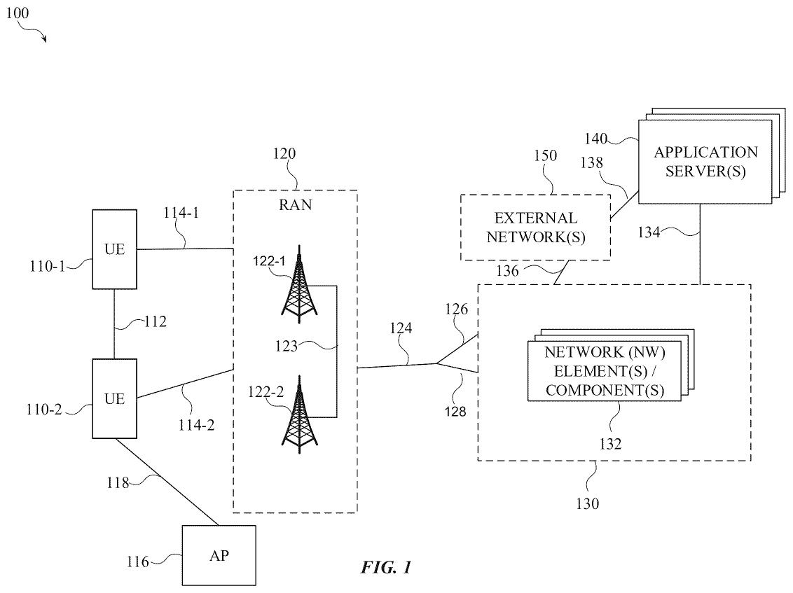

FIG. 1 is an example network 100 according to one or more implementations described herein. Example network 100 may include UEs 110-1, 110-2, etc. (referred to collectively as “UEs 110” and individually as “UE 110”), a radio access network (RAN) 120, a core network (CN) 130, application servers 140, and external networks 150.

The systems and devices of example network 100 may operate in accordance with one or more communication standards, such as 2nd generation (2G), 3rd generation (3G), 4th generation (4G) (e.g., long-term evolution (LTE)), or 5th generation (5G) (e.g., new radio (NR)) communication standards of the 3rd generation partnership project (3GPP). Additionally, or alternatively, one or more of the systems and devices of example network 100 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 110 may include smartphones (e.g., handheld touchscreen mobile computing devices connectable to one or more wireless communication networks). Additionally, or alternatively, UEs 110 may include other types of mobile or non-mobile computing devices capable of wireless communications, such as personal data assistants (PDAs), pagers, laptop computers, desktop computers, wireless handsets, etc. In some implementations, UEs 110 may include internet of things (IoT) devices (or IoT UEs), smart glass over extended reality (XR), as well as vehicle UEs or vehicle device entities, including Vehicle to Everything (V2X) devices, Vehicle to Vehicle (V2V), Vehicle to Infrastructure (V2I) and Vehicle to Pedestrian (V2P) devices or the like. Vehicle device entities can also include a road side unit (RSU), which is an entity that supports V2I and is implemented in an eNodeB or a stationary/non-stationary UE/IoT including any one or more components/circuitry described herein. Such UEs may comprise a network access layer designed for low-power applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 110 may communicate and establish a connection with (e.g., be communicatively coupled) with RAN 120, which may involve one or more wireless channels 114-1 and 114-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 122-1 and 122-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 130. Additionally, at least one of the MN or the SN may be operated with shared spectrum channel access, and functions specified for UE 110 can be used for an integrated access and backhaul mobile termination (IAB-MT). Similar for UE 110, the IAB-MT may access the network using either one network node or using two different nodes with enhanced dual connectivity (EN-DC) architectures, new radio dual connectivity (NR-DC) architectures, or other direct connectivity such as a sidelink communication channel as an SL interface 112.

The NR SL physical layer of the SL interface 112 can be comprised of several physical channels and signals. The SL physical channels are a set of resource elements carrying information of higher layers of the protocol stack. The SL physical channels can include a Physical Sidelink Broadcast Channel (PSBCH) that carries the SL-BCH transport channel where a Master Information Block (MIB) for SL is sent periodically (each 160 ms) and comprises system information for UE-to-UE communication (e.g., SL TDD configuration, in-coverage flag). PSBCH is transmitted along with the Sidelink Primary Synchronization Signal/Sidelink Secondary Synchronization Signal (S-PSS/SSS) in the S-SSB. The SL physical channels can further include a Physical Sidelink Feedback Channel (PSFCH) used to transmit the HARQ feedback from a receiver UE to the transmitter UE (or initiating UE) on the SL for a unicast or groupcast communication. A Physical Sidelink Shared Channel (PSSCH) and Physical Sidelink Control Channel (PSCCH) can be configured so that every PSSCH, which contains transport blocks (i.e., user data traffic), is associated with a PSCCH. The PSCCH can be transmitted on the same slot as PSSCH and contains control information about the shared channel.

In some implementations, a base station (as described herein) may be an example of network node 122. As shown, UE 110 may also, or alternatively, connect to access point (AP) 116 via connection interface 118, which may include an air interface enabling UE 110 to communicatively couple with AP 116. AP 116 may comprise a wireless local area network (WLAN), WLAN node, WLAN termination point, etc. The connection 1207 may comprise a local wireless connection, such as a connection consistent with any IEEE 702.11 protocol, and AP 116 may comprise a wireless fidelity (Wi-Fi®) router or other AP. While not explicitly depicted in FIG. 1, AP 116 may be connected to another network (e.g., the Internet) without connecting to RAN 120 or CN 130. In some scenarios, UE 110, RAN 120, and AP 116 may be configured to utilize LTE-WLAN aggregation (LWA) techniques or LTE WLAN radio level integration with IPsec tunnel (LWIP) techniques. LWA may involve UE 110 in RRC_CONNECTED being configured by RAN 120 to utilize radio resources of LTE and WLAN. LWIP may involve UE 110 using WLAN radio resources (e.g., connection interface 118) via IPsec protocol tunneling to authenticate and encrypt packets (e.g., Internet Protocol (IP) packets) communicated via connection interface 118. IPsec tunneling may include encapsulating the entirety of original IP packets and adding a new packet header, thereby protecting the original header of the IP packets.

RAN 120 may include one or more RAN nodes 122-1 and 122-2 (referred to collectively as RAN nodes 122, and individually as RAN node 122) that enable channels 114-1 and 114-2 to be established between UEs 110 and RAN 120. RAN nodes 122 may include network access points configured to provide radio baseband functions for data or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 122 may include a roadside unit (RSU), a transmission reception point (TRxP or TRP), and one or more other types of base stations. In some scenarios, RAN node 122 may be a dedicated physical device, such as a macrocell base station, or a low power (LP) base station for providing femtocells, picocells or other like having smaller coverage areas, smaller user capacity, or higher bandwidth compared to macrocells.

Some or all of RAN nodes 122 may be implemented as one or more software entities running on server computers as part of a virtual network, which may be referred to as a centralized RAN (CRAN) or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 122; a media access control (MAC)/physical (PHY) layer split wherein RRC, PDCP, radio link control (RLC), and MAC layers may be operated by the CRAN/vBBUP and the PHY layer may be operated by individual RAN nodes 122; or a “lower PHY” split wherein RRC, PDCP, RLC, MAC layers and upper portions of the PHY layer may be operated by the CRAN/vBBUP and lower portions of the PHY layer may be operated by individual RAN nodes 122. This virtualized framework may allow freed-up processor cores of RAN nodes 122 to perform or execute other virtualized applications.

In some implementations, an individual RAN node 122 may represent individual gNB-distributed units (DUs) connected to a gNB-control unit (CU) via individual F1 interfaces. In such implementations, the gNB-DUs may include one or more remote radio heads or radio frequency (RF) front end modules (RFEMs), and the gNB-CU may be operated by a server (not shown) located in RAN 120 or by a server pool (e.g., a group of servers configured to share resources) in a similar manner as the CRAN/vBBUP. Additionally, or alternatively, one or more of RAN nodes 122 may be next generation eNBs (i.e., gNBs) that may provide evolved universal terrestrial radio access (E-UTRA) user plane and control plane protocol terminations toward UEs 110, and that may be connected to a 5G core network (5GC) 130 via an NG interface.

Any of the RAN nodes 122 may terminate an air interface protocol and may be the first point of contact for UEs 110. In some implementations, any of the RAN nodes 122 may fulfill various logical functions for the RAN 120 including, but not limited to, radio network controller (RNC) functions such as radio bearer management, uplink and downlink dynamic radio resource management and data packet scheduling, and mobility management. UEs 110 may be configured to communicate using orthogonal frequency-division multiplexing (OFDM) communication signals with each other or with any of the RAN nodes 122 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 122 to UEs 110, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 122 may be configured to wirelessly communicate with UEs 110, or one another UE, over a licensed medium (also referred to as the “licensed spectrum” or the “licensed band”), an unlicensed shared medium (also referred to as the “unlicensed spectrum” or the “unlicensed band”), or combination thereof. A licensed spectrum may include channels that operate in a frequency range, whereas the unlicensed spectrum may include the 5 GHz band or higher, for example. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 110 and the RAN nodes 122 may operate using NR unlicensed (NR-U), licensed assisted access (LAA), eLAA, or feLAA mechanisms. In these implementations, UEs 110 and the RAN nodes 122 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol or a clear channel assessment (CCA). A category 4 CCA/LBT can be a complete or full CCA compared to a shorter CCA such as a single/one-shot CCA or other CCA (e.g., a CAT 1 CCA or CAT 2 CCA) for sensing whether a channel is busy/reserved or available to acquire for communication.

The LAA mechanisms may be built upon carrier aggregation (CA) technologies of LTE-Advanced systems. In CA, each aggregated carrier is referred to as a component carrier (CC). In some cases, individual CCs may have a different bandwidth than other CCs. In time division duplex (TDD) systems, the number of CCs as well as the bandwidths of each CC may be the same for DL and UL. CA also comprises individual serving cells to provide individual CCs. The coverage of the serving cells may differ, for example, because CCs on different frequency bands will experience different path loss. A primary service cell or PCell may provide a primary component carrier (PCC) for both UL and DL and may handle RRC and non-access stratum (NAS) related activities. The other serving cells are referred to as SCells, and each SCell may provide an individual secondary component carrier (SCC) for both UL and DL. The SCCs may be added and removed as required, while changing the PCC may require UE 110 to undergo a handover. In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different PUSCH starting positions within a same subframe.

The PDSCH may carry user data and higher layer signaling to UEs 110. The physical downlink control channel (PDCCH) may carry information about the transport format and resource allocations related to the PDSCH channel, among other things. The PDCCH may also inform UEs 110 about the transport format, resource allocation, and hybrid automatic repeat request (HARQ) information related to the uplink shared channel. Typically, downlink scheduling (e.g., assigning control and shared channel resource blocks to UE 110-2 within a cell) may be performed at any of the RAN nodes 122 based on channel quality information fed back from any of UEs 110. The downlink resource assignment information may be sent on the PDCCH used for (e.g., assigned to) each of UEs 110.

The PDCCH uses control channel elements (CCEs) to convey the control information, wherein a number of CCEs (e.g., 6 or the like) may consists of a resource element groups (REGs), where a REG is defined as a physical resource block (PRB) in an OFDM symbol. Before being mapped to resource elements, the PDCCH complex-valued symbols may first be organized into quadruplets, which may then be permuted using a sub-block interleaver for rate matching, for example. Each PDCCH may be transmitted using one or more of these CCEs, where each CCE may correspond to nine sets of four physical resource elements known as REGs. Four quadrature phase shift keying (QPSK) symbols may be mapped to each REG. The PDCCH may be transmitted using one or more CCEs, depending on the size of the DCI and the channel condition. There may be four or more different PDCCH formats defined in LTE with different numbers of CCEs (e.g., aggregation level, L=1, 2, 4, 8, or 16).

Some implementations may use concepts for resource allocation for control channel information that are an extension of the above-described concepts. For example, some implementations may utilize an extended (E)-PDCCH that uses PDSCH resources for control information transmission. The EPDCCH may be transmitted using one or more ECCEs. Similar to the above, each ECCE may correspond to nine sets of four physical resource elements known as EREGs. An ECCE may have other numbers of EREGs in some situations.

The RAN nodes 122 may be configured to communicate with one another via interface 123. In implementations where the system is an LTE system, interface 123 may be an X2 interface. The X2 interface may be defined between two or more RAN nodes 122 (e.g., two or more eNBs/gNBs or a combination thereof) that connect to evolved packet core (EPC) or CN 130, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 110 from an SeNB for user data; information of PDCP PDUs that were not delivered to a UE 110; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 120 may be connected (e.g., communicatively coupled) to CN 130 via a Next Generation (NG) interface 124. The NG interface 124 can be split into two parts, a Next Generation (NG) user plane (NG-U) interface 128, which carries traffic data between the RAN nodes 122 and a User Plane Function (UPF), and the S1 control plane (NG-C) interface 126, which is a signaling interface between the RAN nodes 122 and Access and Mobility Management Functions (AMFs). The Core network CN 130 can also be a 5G core network (5GC) 220.

CN 130 may comprise a plurality of network elements 132, which are configured to offer various data and telecommunications services to customers/subscribers (e.g., users of UEs 110) who are connected to the CN 130 via the RAN 120. In some implementations, CN 130 may include an evolved packet core (EPC), a 5G CN, or one or more additional or alternative types of CNs. The components of the CN 130 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 130 may be referred to as a network slice, and a logical instantiation of a portion of the CN 130 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 130, application servers 140, and external networks 150 may be connected to one another via interfaces 134, 136, and 138, which may include IP network interfaces. Application servers 140 may include one or more server devices or network elements (e.g., virtual network functions (VNFs) offering applications that use IP bearer resources with CM 130 (e.g., universal mobile telecommunications system packet services (UMTS PS) domain, LTE PS data services, etc.). Application servers 140 may also, or alternatively, be configured to support one or more communication services (e.g., voice over IP (VOIP sessions, push-to-talk (PTT) sessions, group communication sessions, social networking services, etc.) for UEs 110 via the CN 130. Similarly, external networks 150 may include one or more of a variety of networks, including the Internet, thereby providing the mobile communication network and UEs 110 of the network access to a variety of additional services, information, interconnectivity, and other network features.

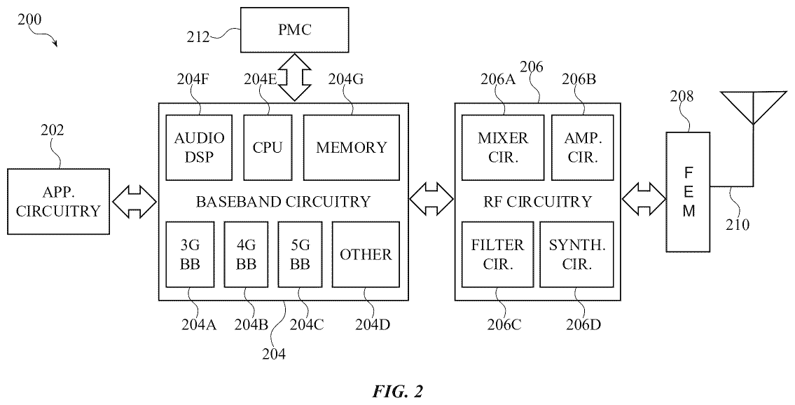

FIG. 2 illustrates example components of a device 200 in accordance with some aspects. In some aspects, the device 200 can include application circuitry 202, baseband circuitry 204, Radio Frequency (RF) circuitry 206, front-end module (FEM) circuitry 208, one or more antennas 210, and power management circuitry (PMC) 212 coupled together at least as shown. The components of the illustrated device 200 can be included in a UE or a RAN node. In some aspects, the device 200 can include fewer elements (e.g., a RAN node cannot utilize application circuitry 202, and instead include a processor/controller to process IP data received from a CN (e.g., 5GC 120 or an Evolved Packet Core (EPC)).

The application circuitry 202 can include one or more application processors. For example, the application circuitry 202 can include circuitry such as, but not limited to, one or more single-core or multi-core processors. The processor(s) can include any combination of general-purpose processors and dedicated processors (e.g., graphics processors, application processors, etc.). The processors can be coupled with, or can include, memory/storage configured to execute instructions stored in the memory/storage to enable various applications or operating systems to be executed on the device 200.

The baseband circuitry 204 can include circuitry such as, but not limited to, one or more single-core or multi-core processors. The baseband circuitry 204 can include one or more baseband processors or control logic to process baseband signals received from a receive signal path of the RF circuitry 206 and to generate baseband signals for a transmit signal path of the RF circuitry 206. Baseband circuity 204 can interface with the application circuitry 202 for generation and processing of the baseband signals and for controlling operations of the RF circuitry 206. For example, in some aspects, the baseband circuitry 204 can include a third generation (3G) baseband processor 204A, a fourth generation (4G) baseband processor 204B, a fifth generation (5G) baseband processor 204C, or other baseband processor(s) 204D for other existing generations, generations in development or to be developed in the future (e.g., second generation (2G), sixth generation (6G), etc.). The baseband circuitry 204 (e.g., one or more of baseband processors 204A-D) can handle various radio control functions that enable communication with one or more radio networks via the RF circuitry 206. In other aspects, some, or all of the functionality of baseband processors 204A-D can be included in modules stored in the memory 204G and executed via a Central Processing Unit 204E. Memory 204G can include executable components or instructions to cause one or more processors (e.g., baseband circuitry 204) to perform aspects, processes or operations herein. The radio control functions can include, but are not limited to, signal modulation/demodulation, encoding/decoding, radio frequency shifting, etc. In some aspects, modulation/demodulation circuitry of the baseband circuitry 204 can include Fast-Fourier Transform (FFT), precoding, or constellation mapping/de-mapping functionality. In some aspects, encoding/decoding circuitry of the baseband circuitry 204 can include convolution, tail-biting convolution, turbo, Viterbi, or Low Density Parity Check (LDPC) encoder/decoder functionality. Aspects of modulation/demodulation and encoder/decoder functionality are not limited to these examples and can include other suitable functionality in other aspects.

In some aspects, the baseband circuitry 204 can include one or more audio digital signal processor(s) (DSP) 204F. The audio DSP(s) 204F can include elements for compression/decompression and echo cancellation and can include other suitable processing elements in other aspects. Components of the baseband circuitry can be suitably combined in a single chip, a single chipset, or disposed on a same circuit board in some aspects. In some aspects, some, or all of the constituent components of the baseband circuitry 204 and the application circuitry 202 can be implemented together such as, for example, on a system on a chip (SOC).

In some aspects, the baseband circuitry 204 can provide for communication compatible with one or more radio technologies. For example, in some aspects, the baseband circuitry 204 can support communication with a NG-RAN, an evolved universal terrestrial radio access network (EUTRAN) or other wireless metropolitan area networks (WMAN), a wireless local area network (WLAN), a wireless personal area network (WPAN), NR-U network, etc. Aspects in which the baseband circuitry 204 is configured to support radio communications of more than one wireless protocol can be referred to as multi-mode baseband circuitry.

RF circuitry 206 can enable communication with wireless networks using modulated electromagnetic radiation through a non-solid medium. In various aspects, the RF circuitry 206 can include switches, filters, amplifiers, etc. to facilitate the communication with the wireless network. RF circuitry 206 can include a receive signal path which can include circuitry to down-convert RF signals received from the FEM circuitry 208 and provide baseband signals to the baseband circuitry 204. RF circuitry 206 can also include a transmit signal path which can include circuitry to up-convert baseband signals provided by the baseband circuitry 204 and provide RF output signals to the FEM circuitry 208 for transmission.

In some aspects, the receive signal path of the RF circuitry 206 can include mixer circuitry 206a, amplifier circuitry 206b and filter circuitry 206c. In some aspects, the transmit signal path of the RF circuitry 206 can include filter circuitry 206c and mixer circuitry 206a. RF circuitry 206 can also include synthesizer circuitry 206d for synthesizing a frequency for use by the mixer circuitry 206a of the receive signal path and the transmit signal path. In some aspects, the mixer circuitry 206a of the receive signal path can be configured to down-convert RF signals received from the FEM circuitry 208 based on the synthesized frequency provided by synthesizer circuitry 206d. The amplifier circuitry 206b can be configured to amplify the down-converted signals and the filter circuitry 206c can be a low-pass filter (LPF) or band-pass filter (BPF) configured to remove unwanted signals from the down-converted signals to generate output baseband signals. Output baseband signals can be provided to the baseband circuitry 204 for further processing. In some aspects, the output baseband signals can be zero-frequency baseband signals, although this is not a requirement. In some aspects, mixer circuitry 206a of the receive signal path can comprise passive mixers, although the scope of the aspects is not limited in this respect.

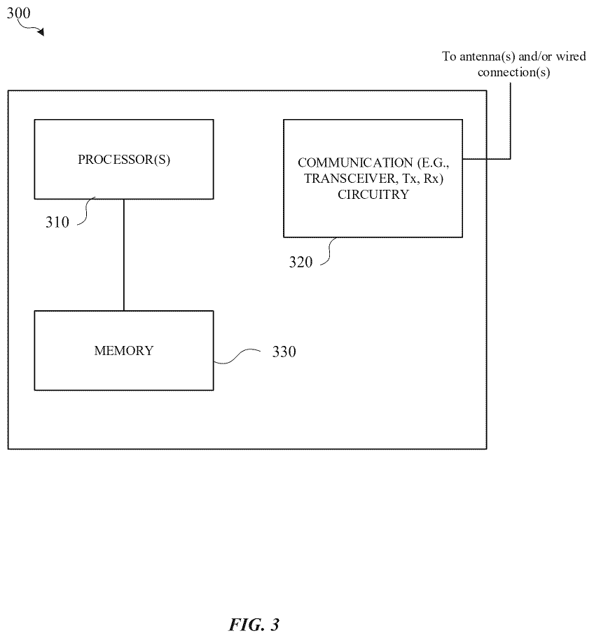

Referring to FIG. 3, illustrated is a block diagram of a user equipment (UE) device or another network device/component (e.g., V-UE/P-UE, IoT, gNB, eNB, or other participating network entity/component). The device 300 includes one or more processors 310 (e.g., one or more baseband processors) comprising processing circuitry and associated interface(s), transceiver circuitry 320 (e.g., comprising RF circuitry, which can comprise transmitter circuitry (e.g., associated with one or more transmit chains) or receiver circuitry (e.g., associated with one or more receive chains) that can employ common circuit elements, distinct circuit elements, or a combination thereof), and a memory 330 (which can comprise any of a variety of storage mediums and can store instructions or data associated with one or more of processor(s) 310 or transceiver circuitry 320).

Memory 330 (as well as other memory components discussed herein, e.g., memory, data storage, or the like) can comprise one or more machine-readable medium/media including instructions that, when performed by a machine or component herein cause the machine or other device to perform acts of a method, an apparatus or system for communication using multiple communication technologies according to aspects, embodiments and examples described herein. It is to be understood that aspects described herein can be implemented by hardware, software, firmware, or any combination thereof. When implemented in software, functions can be stored on or transmitted over as one or more instructions or code on a computer-readable medium (e.g., the memory described herein or other storage device). Computer-readable media includes both computer storage media and communication media including any medium that facilitates transfer of a computer program from one place to another. A storage media or a computer readable storage device can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or other tangible or non-transitory medium, that can be used to carry or store desired information or executable instructions. Also, any connection can also be termed a computer-readable medium.

Memory 330 can also include executable instructions either in or communicatively coupled to processor or processing circuitry 310. For example, the memory can include performing sensing of candidate resources on an LTE sidelink resource pool of an LTE sidelink channel and an NR resource pool of an NR sidelink channel for SL communication on an NR SL channel based on sensing results of the sensing of the candidate resources. Communication/transceiver circuitry 320 can further transmit, according to the sensing results, the SL communication on the NR sidelink channel based on a set of LTE candidate resources of the LTE sidelink channel and a set of NR candidate resources of the NR sidelink channel in a co-channel coexistence.

In an aspect, the UE/gNB device 300 can operate to configure by processing/generating/encoding/decoding a physical (PHY) layer transmission to/from a higher layer (e.g., MAC layer), comprising multiple different transport blocks (TBs) based on an unequal protection between the different TBs in a physical layer encapsulation (e.g., EPC packets, a transmission opportunity, MCOT, a single transmission burst, a TTI or other encapsulation protocol or related encapsulation parameter(s) for the encapsulation of data from higher layers into frames for transmission over the air. The physical (PHY) layer transmission can be received, transmitted, or provide (d) with communication/transmitter circuitry 320 to similarly process/generate the physical layer transmission with spatial layers via a physical channel in an NR network or other networks.

Processor(s) or processing circuitry 310 can be components of application/processing circuitry or processor(s) of the baseband circuitry that can be used to execute components or elements of one or more instances of a protocol stack. For example, processor(s) 310 of baseband circuitry, alone or in combination, as processing circuitry, can be configured, in an aspect, to a receiver UE (e.g., 110-2, or other UE) for NR mode-2 SL communication or LTE mode-4 SL communication. Because NR mode-2 SL communication and LTE mode-4 communication include SL communication where a base station does not intervene in resource allocation, the processing circuitry 310 can further perform a resource selection procedure of a set of candidate resources (or a candidate resource set (S_{A})), and further so that at least a subset of candidate resources of the set of candidate resources satisfies a threshold (e.g., a reference signal received power (RSRP), or the similar power threshold). For example, a threshold amount (by percentage, ratio, or number) of the candidate resource set (S_{A}), or the subset of candidate resources can overlap with a total number of candidate resources (S_{M}). After ensuring the threshold is satisfied a report of the set of candidate resources can be transmitted from the PHY layer to a higher layer (e.g., a MAC layer) to enable SL communication. Additionally, a full sensing window or partial sensing with a partial sensing window can be configured as a part of the resource selection procedure. Various aspects can also consider processes or process flow that takes into account when the subset of candidate resources of the candidate resource set (S_{A}) is below the threshold.

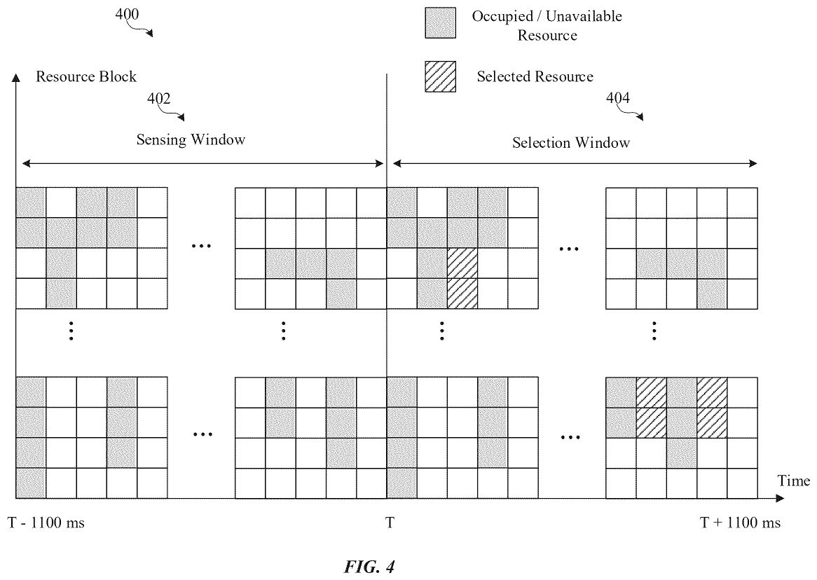

FIG. 4 illustrates an example timing of a sensing and selection process 400 in accord with various aspects. In the 5G NR mode-2 SL communication, the base station does not intervene in the resource selection process of the UE or terminal node, as such each UE selects the usable resources itself. Each UE performs the sensing procedure 402 by decoding the PSCCH to determine which resources are not occupied by other terminals. Resource sensing 402 can be performed by a UE (e.g., UE 110-1 as a transmitting UE to a receiving UE 110-2) prior to data transmission, or prior to the transmitting UE transmitting/reporting to the receiver UE, which can be from PHY layer to a higher layer (e.g., a MAC layer or beyond) for LTE SL and NR SL communications in co-channel coexistence, in which time and frequency resources are shared or overlap for both in one SL channel.

In the example timing of sensing and selection processes 400, the length of the sensing window 402 is set to 1100 ms, but can be larger or smaller (e.g., 100 ms) as a complete or full sensing window based on a resource pool configuration. The timing of the sensing and selection process 400 corresponds to full sensing, which can be applied to various UEs (e.g., V-UEs or other UEs), for which considerably less severe restrictions on power consumption are imposed, but is not limited to any particular UE. “T” denotes the timing corresponding to the start of the selection window. The sensing window 402 starts at time T−1100 ms, that is, 1100 ms before T.

During the sensing window 402 period, each terminal undergoes a sensing process of decoding the PSCCH resource blocks being used by all UEs of an area. Thus, resource sensing 402 can be used to identify the occupied resources (e.g., as indicated by shaded resources/resource blocks) and to exclude these occupied resource blocks from the candidate resource set (or set of candidate resources). Some resources may also not be available if the UE is not monitoring these. After the candidate resource set is obtained through the sensing process 402, the resource blocks to be used for data transmission are selected from the total candidate resources minus the excluded or unavailable resources during the selection window 404. Through this process, even if the base station does not allocate resource blocks, the UE 110-1, for example, can identify the resource blocks being used by all other terminals, and thus prevent collision by selecting adequate resource candidates (e.g., as indicated in hash marked resource blocks) for SL communication. Here, at least a subset of NR SL candidate resources of the candidate resources being reported can be determined to overlap with LTE SL candidate resources, such as by enabling resource selection details for SL communication in co-channel coexistence with LTE SL and NR SL based on partial sensing approaches and alongside corresponding agreements in 3GPP.

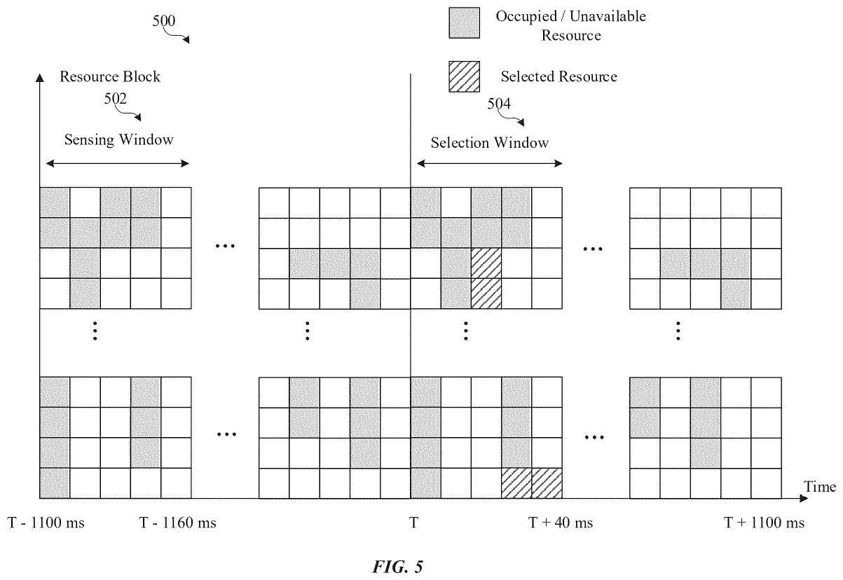

FIG. 5 illustrates an example timing of a partial sensing/reduced sensing and selection process 500 in accord with various aspects. Sensing is performed for only a partial sensing window 502 (e.g., 40 ms or other partial period) of an entire or full observation period of 200 ms as full sensing, which is a smaller portion or a partial window of full sensing (e.g., sensing window 402, or other window time larger than a partial period). “T” denotes the timing where the resource selection window (RSW) 504 begins. Here, for example, sensing at each UE is performed only for 40 ms, corresponding to the time interval from T−1100 ms to T−160 ms. Because PSCCH decoding is performed for 40 ms (T−1100 ms to T−160 ms), the RSW 504 can be reduced to 40 ms (from T to T+40 ms), as one example.

One purpose of partial sensing is for the UE to perform sensing with reduced power consumption for efficiency. The power consumption of the UE can be directly linked to the duration of the sensing, therefore reducing the sensing duration (i.e., partial sensing), can enable power saving. However, if the sensing duration is extremely reduced, the system performance can degrade. Thus, partial sensing also allows the UE 110-1, for example, as a transmitting UE in sidelink communications to avoid selecting some resources which are reserved by other UEs, and not necessarily always be able to detect any reserved resource(s) (e.g., control channel elements (CCEs) or CCE candidates, subframes, bandwidth, frequency, transmission opportunity, number of antenna ports, orthogonal frequency division symbols, other resources, or resource parameters) with higher periodicity, which could share the same selection window.

Example agreements that could be standardized with 3GPP include resource allocation procedures as described throughout herein this disclosure with sensing of both LTE SL resources of an LTE channel and NR SL resources of an NR channel in co-channel coexistence on a single SL channel, such as for NR SL data transmission, or other data. Sensing of the candidate resources can be performed by the UE 110-1, for example, on an LTE sidelink resource pool of the LTE sidelink channel during an LTE sensing window and on the NR sidelink resource pool of the NR sidelink channel in co-channel coexistence with the LTE sidelink channel during an NR sensing window. The LTE sensing window can be configured for a full sensing operation or a partial sensing operation in the LTE sidelink channel, and the NR sensing window can be configured for the full sensing operation or the partial sensing operation in the NR sidelink channel in order to provide an SL transmission (e.g., an NR data transmission, sidelink control information (SCI) transmission, or other data) via an SL transmission based on these various aspects including both sensing on the LTE SL and the NR SL.

While the methods described within this disclosure are illustrated in and described herein as a series of acts or events, it will be appreciated that the illustrated ordering of such acts or events are not to be interpreted in a limiting sense. For example, some acts can occur in different orders or concurrently with other acts or events apart from those illustrated or described herein. In addition, not all illustrated acts can be required to implement one or more aspects or embodiments of the description herein. Further, one or more of the acts depicted herein can be carried out in one or more separate acts or phases. Reference can be made to the figures described above for ease of description. However, the methods are not limited to any particular embodiment, aspect or example provided within this disclosure and can be applied to any of the systems/devices/components disclosed herein.

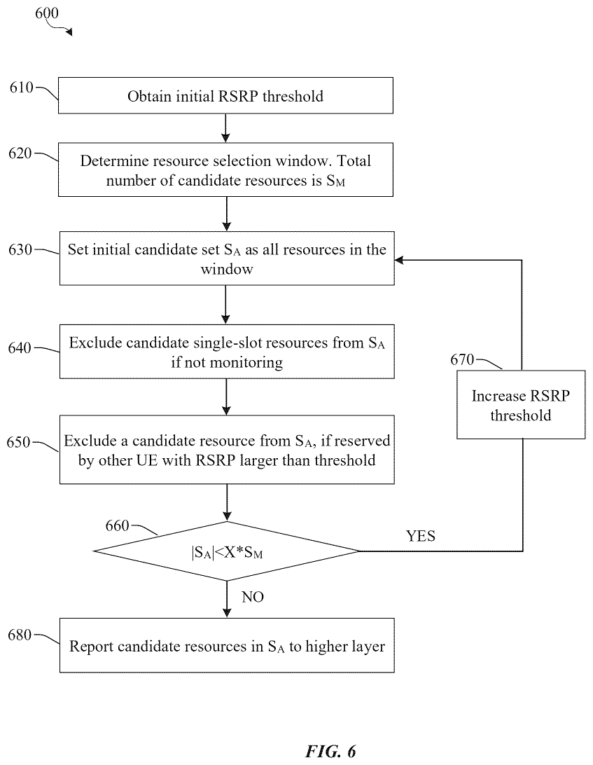

FIG. 6 illustrates an example process flow 600 of a sensing and resource candidate selection process 600 in accord with various aspects. NR V2X UE SL communication can be configured with two different resource allocation modes, namely mode 1 and mode 2 resource allocation schemes. For Mode 2 resource allocation scheme, the transmitting UE (e.g., UE 110-1) selects the sidelink transmission resources based on its own sensing and resource selection procedure. Previously, the UE did not necessarily consider SL from the Rx UE 110-2 so that no side information is reported from the Rx UE 110-2, for example. However, the UE 110-1 as a transmitting UE can be configured to receive reporting from the receiving UE 110-2 to select some resources, or operate based on its own sensing and SL resource pools. In NR V2X, the UE 110-1 can operate resource selection procedures that includes identifying a set of candidate resources.

In the 5G NR mode-2 SL communication and in LTE mode-4 SL communication, the base station 120 does not intervene in the resource selection process of the UE or terminal node, as such each UE selects the usable resources itself. In contrast, NR mode-1 communication receives an allocation of resources from the base station 120. In NR mode-2 and LTE mode-4 SL communications, each UE performs the sensing procedure 600 by decoding the PSCCH to determine which resources are not occupied by other terminals. Resource sensing 602 is performed prior to data transmission, or prior to the UE (e.g., UE 110-1) transmitting to a receiver UE (e.g., UE 110-2), which can be from PHY layer to a higher layer (e.g., a MAC layer or beyond).

In the example timing of sensing and selection process flow 600, at 610 the UE 110-1 obtains an initial RSRP threshold (or measurement threshold), which can be based on a quality of service (QOS) of the sidelink data to be transmitted. The sensing window is used to monitor resources from other UEs as well as perform sidelink received signal strength indicator (S-RSSI)/RSRP measurements to select the most suitable resources within a selection window for use in SL communication.

At 620, the process flow 600 includes determining a resource selection window with a total number S_{M} of candidate resources Mₜₒₜₐₗ when the UE 110-1 obtains data to transmit and is triggered to determine resources within this window. This determination can be based on a total number of sidelink candidate resources (M) within a period, a timed window, or a time of potential candidate resources. The PHY layer of the transmitting UE 110-1 determines the parameters of a resource selection window (e.g., RSW 504, or other window) and the total number of the candidate resources in this window denoted as M. The RSW, for example can be denoted as [n+T1, n+T2], where n can be a time of the resource selection slot, and T1 the beginning slot time offset and T2 the ending slot time offset. The sensing window can be configured for sensing before the RSW (e.g., 504) to decode a PSCCH, and can be partial sensing window or full sensing window, for example, depending on a mode 2 for NR sensing and whether LTE sensing is in mode 4 in sidelink co-channel coexistence.

At 630, an initial candidate resource set S_{A} can be initialized to include all the resources in the resource selection window. This initial candidate resource set S_{A} can be within the total number of candidate resources Sm. Here, all the resources within a timed resource selection window can be set as a candidate resource set/set of candidate resources, denoted as S_{A}, or referred to as the initial candidate set as all resources in the resource selection window (e.g., 504).

At 640, the UE 110-1 can exclude candidate resources from the candidate resource set S_{A} that the UE 110-1 does not sense resources in a sensing resource window with configured resource reservation periods before a candidate slot. Here, the UE may identify resources that are unknown whether a resource reservation information is associated on this slot.

At 650, the UE 110-1 can exclude candidate resources from the candidate resource set S_{A}, which can be based on reservation of candidate resources of another UE's reservation. Here, the transmitting UE 110-1 excludes resources by determining whether other UEs have reserved the resources, such as by decoding the SCI of other UE transmissions to determine if there is an associated reservation. If the UE 110-1 detects that some resources have been reserved by another UE by performing sensing operations, the UE 110-1 can exclude those reserved resources from the candidate resource set S_{A}, especially by another UE with an RSRP threshold that is larger than the RSRP threshold used for the resource selection process flow. Transmissions that are received by the UE 110-1 can occupy resources, which are periodically allocated and can be projected onto some resources within the UE (re)selection window (n) (e.g., window 504). Thus, because the UE (e.g., 110-1) knows these resources are already occupied by its reception of these transmission, the UE 110-1 can operate to exclude these resources from a resource candidate set (e.g., a dataset storage, or other storage) as reserved for retransmission by another UE device or network component, for example. The UE 110-1 can independently treat each partial sensing window allocated, for example, within a period of seconds, milliseconds (ms) or other complete sensing window. Thus, if multiple partial sensing windows are configured within a configured sensing window, the UE 110-1 can independently process each of them, detect all corresponding resource reservation periods and corresponding resources to be excluded from use in selecting resources and generating an SL transmission.

Additionally, or alternatively, the UE 110-1 can evaluate whether the other UEs are transmitting higher than an RSRP threshold, which can depend also on a data priority level of the reserving SCI. If another UE is in close proximity to the transmitting UE 110-1, an associated signal strength is going to be larger; and thus, if selecting the same resource a large interference from the other UE's reservation could result. The UE 110-1 can check RSRP measurements of the resources with the RSRP threshold.

At 660, the UE 110-1 can determine whether the number of resources in the candidate resource set S_{A} is smaller than X*Mₜₒₜₐₗ or X*S_{M}, where X can be a positive integer or percentage, for example. If the determination is “yes”, then at 670 the UE 110-1 can increase the RSRP threshold (e.g., a 3 dB increase), and repeat 630 thru 650. For example, the UE 110-1 can determine if any of the remaining resources are available, and if the remaining resources are a certain percentage of the total number of resources and re-perform, in another iteration, the processes 630 thru 650 by increasing the RSRP threshold; thereby, giving a less likely chance of to exclude some resources and potentially make the candidate resource set S_{A} larger. Once an X percentage of the total number of resources S_{M} are within the candidate set, then the UE 110-1 can report the candidate results to a higher layer for a random resource selection. In other words, if “no” is the determination at 680, then the UE 110-1 can report the candidate resource set S_{A} to a higher layer.

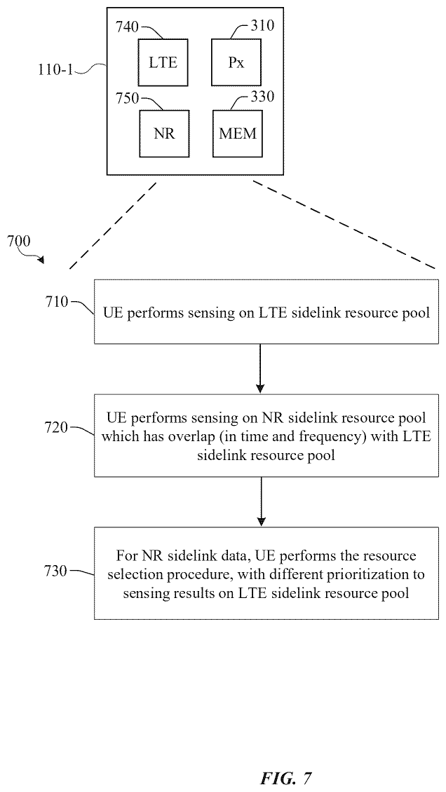

Referring to FIG. 7, illustrated is an example process flow 700 for resource allocation with sensing of an LTE sidelink channel and an NR sidelink channel in accord with various aspects. The UE 110-1 can operate to configure an SL channel with co-channel coexistence between LTE sidelink and NR sidelink, in which the LTE sidelink is in LTE mode-4 and the NR sidelink is in NR mode 2; thus, the UE 110-1 can select resources by itself without network involvement for both NR SL and LTE SL. Because the UE 110-1 operates to generate co-channel coexistence, an NR sidelink UE's resource allocation procedure takes into account the LTE SL resource reservation for resource allocation. Although the resources for NR SL transmission may at least partially come from the NR resource reservation, the transmission resource candidates may also come from the LTE SL resource reservation. The SL channel can thus be generated to share the same time and frequency resources for both LTE SL and NR SL in a same SL channel in co-channel coexistence for transmitting data, such as NR data or LTE data.

In the example process flow 700 of FIG. 7, the UE 110-1 has the capability to operate in mode 2 and mode 4 for NR and LTE, respectively, for sidelink communication in an SL channel in co-channel coexistence. At 710, the UE 110-1 performs sensing on an LTE SL resource pool as an initial step in mode 4 operation.

At 720, the UE 110-1 can then perform sensing on the NR SL resource pool that overlaps in time and frequency with the LTE SL resource pool. By operating in mode 2 for NR sidelink data, at 730 the UE 110-1 can select resources for NR SL transmission based on the sensing results from both LTE SL and NR SL in a resource selection procedure. The resources may have different priorities corresponding to the sensing results for LTE SL and NR SL, respectively. The UE 110-1 considers both LTE and NR SL when selecting the resources for NR SL transmission through the NR sidelink UE resource selection operations with co-channel coexistence while taking into account these priorities.

In an aspect, UE 110-1 can comprise different modules or components, including an LTE SL module component 740 and an NR SL module component 750 that can be configured to perform the process flow 700 for SL co-channel coexistence. The LTE module component 740 can be configured to perform sensing on the LTE sidelink resource pool at 710 and the NR SL module component 750 can be configured to perform sensing on the NR sidelink resource pool that overlaps in time and frequency in co-channel coexistence with the LTE sidelink resource pool. In one example, the NR SL module component 750 can perform sensing based on the sensing results of the LTE sidelink resource pool from the LTE module component 740. The LTE SL module component 740 passes its sensing result to the NR SL module component 750 to facilitate NR SL resource selection at 730 of process flow 700.

UE 110-1 is configured with in-device coexistence capability for a short-term time division multiplexing (TDM); thus, the LTE resources and NR resources could be shortened accordingly based on an information exchange within the UE between LTE sidelink and NR sidelink resources, particularly from LTE SL module component 740 to the NR SL module component 750; although the reverse, from NR SL module component 750 to LTE SL module component 740, is foreseeable. The UE 110-1 configures the LTE sidelink resource pool with a time-frequency overlap with the NR sidelink resource pool for co-channel coexistence with the NR sidelink resource pool by considering the different NR and LTE resources available and with different prioritization to sensing results in the different NR and LTE resource pools.

In an aspect, LTE sidelink sensing results, for example, can be treated with a higher prioritization than NR SL sensing results by UE 110-1; although the reverse can be configured as well. Considering that the LTE sidelink operations does not necessarily perform the resource re-evaluation and pre-emption operations, means that the NR SL resources are more protected and may do the resource re-evaluation/pre-emption operations to ensure the resource reservation(s) are still available, which is not always the same with the LTE SL operations.

It is possible that one or multiple LTE resource pools overlap with the NR resource pools. As such, the LTE SL module component 740 of SL UE 110-1 is not necessarily transmitting data to another UE (e.g., UE 110-2), but receiving data. The LTE SL module component 740 thus can perform sensing operations or channel measurements, not needing to transmit data outside the UE 110-1, as with the NR SL module component 750.

UE 110-1 can perform sensing of candidate resources for transmissions on both an LTE sidelink resource pool and NR sidelink resource pool at 710 and 720 of process flow 700. The UE 110-1 can determine whether to sense the LTE resource pool or not. The UE's NR SL module component 750 can select a transmit resource pool. The NR SL module component 740 can check the LTE SL, such as the V2X system information block(s) (SIB(s)), and identify one or more LTE transmit resource pool(s) that overlap with a selected NR transmit pool. If any overlap in resources (time and frequency resources) is determined, it can then perform sensing only on the LTE SL. For each of the LTE transmit pool(s), the UE 110-1 can conduct sensing.

Additionally, the UE 110-1 can have NR SL data to transmit in an SL channel to a receiving UE (e.g., 110-2). Then the UE 110-1 can perform the NR sidelink resource selection procedure 700 by considering co-channel coexistence by taking into account the LTE SL and NR SL. In one example, the LTE sidelink sensing results can be treated with a higher prioritization for transmission, such as for V2X SL transmission.

In an aspect, alternatively, or additionally, the NR SL could be in NR sidelink mode 1, meaning the base station (e.g., gNB 120) controls the NR SL resources, and concurrently the UE 110-1 operates on LTE sidelink mode 4 (where the UE 110-1 can independently perform the sensing of the LTE SL without resource allocation from the base station). In this scenario, the NR sidelink UE 110-1 can report the LTE sidelink sensing results to gNB 120 for the gNB 120 to consider the LTE SL channel occupants when allocating resources.

In an aspect, the UE 110-1 can perform sensing of the candidate resources on the LTE sidelink resource pool of an LTE sidelink channel during an LTE sensing window and on the NR sidelink resource pool of an NR sidelink channel in co-channel coexistence with the LTE sidelink channel during an NR sensing window. The LTE sensing window can be configured for a full sensing operation or a partial sensing operation in the LTE sidelink channel, and the NR sensing window can be configured for the full sensing operation or the partial sensing operation in the NR sidelink channel. Depending on the configurations of the LTE sensing window and the NR sensing window, the UE 110-1 can perform the resource selection accordingly so that one configuration can depend on another, such as a full/partial LTE sensing window dependent on an NR full/partial sensing window, or vice versa also.

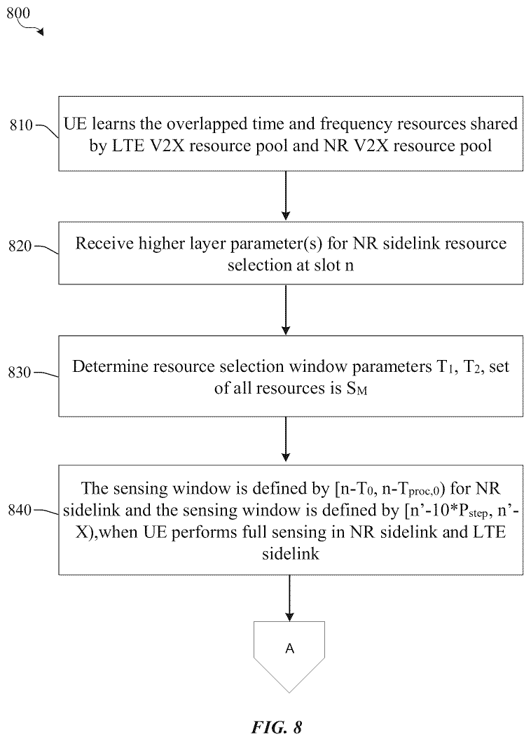

Referring to FIG. 8, illustrated is another example process flow 800 for resource allocation in co-channel coexistence according to aspects for full sensing in NR SL resources and LTE SL resources. Process flow 800 further details configuration of a sensing window for the resource allocation and selection operations with sensing in co-channel coexistence when UE 110-1 utilizes LTE SL and NR SL sensing. The resource selection window can be past in time such that, for example, the NR SL resource pool selection procedure starts at slot n, then the first case is the full sensing on LTE and NR SL.

During the resource sensing window or sensing window period, each terminal undergoes the sensing process of decoding physical sidelink control channel (PSCCH) resource blocks being used by all UEs of an area. Thus, sensing can be used to identify the occupied resources and to exclude these occupied resource blocks from a candidate resource set. Some resources may also not be available if the UE is not monitoring these or they are with reservation from other UEs. After the candidate resource set is obtained through the sensing process, the resource blocks to be used for data transmission are selected from the total candidate resources minus the excluded or unavailable resources during the selection window. Through this process, even if the base station does not allocate resource blocks, the UE can identify the resource blocks being used by all other terminals and thus prevent collision by selecting adequate resource candidates for SL communication.

In an aspect, both LTE and NR resources pools can be sensed by performing full sensing, or without power saving based sensing where sensing is performed over a shorter duration (e.g., 40 milliseconds (ms) or other partial period) compared to full sensing for an entire observation period (e.g., 200 ms or other period longer than a partial sensing window) from beginning to end.

Process flow 800 can be executed by UE 110-1 for determining a sensing window for preforming resource selection, for example, as in process flow 700. At 810, the process flow 800 initiates with the UE 110-1 identifying overlapping time and frequency resources shared by an LTE resource pool (e.g., an LTE V2X resource pool) and an NR resource pool (e.g., an NR V2X resource pool). At 820, a higher layer parameter can be received for NR SL resource selection at slot n. At 830, resource selection window parameters (e.g., T₁, T₂) can be processed, with the set of all resources Sₘ, based on a sensing window configuration. A resource sensing window, for example, can be denoted as [n+T₁, n+T₂], where n can be a time of the resource selection slot, and T1 the beginning slot time offset and T2 the ending slot time offset of the sensing window. At 840, an NR sensing window can be configured according to [n−T₀, n−T_{proc, 0}] for the NR sidelink and the LTE sensing window configured according to [n′−10*Pₛₜₑₚ, n′−1], when the UE 110-1 performs full sensing in the NR SL and the LTE SL resources.

The UE 110-1 can perform full sensing operations in the NR sidelink channel during an NR sensing window and in the LTE sidelink channel during an LTE sensing window, based on overlapping time and resources between the LTE sidelink resource pool and the NR sidelink resource pool. An NR sensing window can be generated based on an initial NR slot (n), which can trigger an NR sidelink resource selection procedure 800, a sidelink (SL)-sensing window parameter of one or more slots that can be preconfigured, and a processing time (T_{proc,0}) of the sensing results, in which n can be an integer. The LTE sensing window can be based on an LTE logical or physical subframe (n′) that corresponds to the initial NR slot (n), a FDD/TDD configuration parameter, and a predefined positive integer or an in-device coordination time between an LTE sidelink module component and an NR sidelink module component.

The sensing window for the NR SL can be represented as: [n−T₀, n−T_{proc,0}], where the parameter T_{proc,0} can be a processing time of a sensing result, and T₀ can be a period of time, such as 100 ms or other time increment based on a resource pool configuration or parameter. T₀ for example can be equal to the sl-SensingWindow (pre) configured for NR sidelink resource pool. Thus, UE 110-1, upon completing sensing, uses the sensing results in this NR sensing window for data transmission.

Then for LTE SL, the LTE sensing window can be represented as: [n′−10*Pₛₜₑₚ, n′−1], in which parameter n′ is different from the slot n of the NR domain and be an LTE subframe that is an LTE logical or physical subframe. The n′−1 portion of the sensing window can correspond to an LTE SL subframe in order to allocate one subframe to process and decode the sensing results. As such, UE 110-1 can correspond the LTE sensing window into the NR slot n by mapping from slot n to subframe n′. The parameter Pₛₜₑₚ (e.g., 100 ms for FDD, or other time increment) can be dependent on an FDD/TDD configuration or parameter, for example.

Alternatively, or additionally, the LTE sensing window can be represented as: [n′−10*Pₛₜₑₚ, n′−X], in which the LTE SL window could end earlier as denoted by minus X and ensure the LTE SL module component 740 passes its sensing results to the NR SL module component 750, or across different SL module components of the UE 110-1. Thus, additional processing time X can be factored into the LTE sensing window configuration because involves passing sensing results of candidate resources across different SL modules. The additional processing time X can be larger than 1, for example, such as 2 ms, 3 ms, 4 ms, or the like, and may depend on the UE capability of UE 110-1 according to an in-device coordination time to pass the sensing results from LTE SL module component 740 to NR SL module component 750.

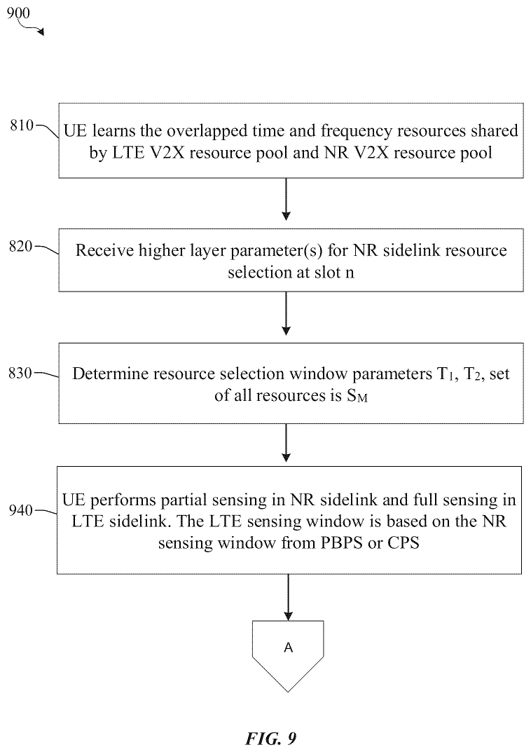

Referring to FIG. 9, illustrated is another example process flow 900 for resource allocation in co-channel coexistence according to aspects for partial sensing in NR SL resources and full sensing in LTE SL resources. For NR SL resources, partial sensing can be performed in a portion of slots within or less than a full sensing window period. The process flow 900 can have similar acts as 810 thru 830 in FIG. 8, and additionally include at 940 performing partial sensing in the NR SL and full sensing in the LTE SL, in which the LTE sensing window can be based on the NR sensing window periodic-based partial sensing (PBPS) or contiguous partial sensing (CPS).

In an aspect, periodic-based partial sensing or PBPS can be configured for partial sensing of the NR SL resources, in which the UE 110-1 monitors slot resources (e.g., sensing occasions). If the UE 110-1 determines that any slots are candidate resource slots, then the UE 110-1 selects a corresponding earlier slot for sensing, in which the time for slot sensing can be represented as: t_{y-k*Preserve}, where t_{y} is a selected resource candidate slot, and K can be 1 or 2 based on a resource pool configuration (e.g., an additional Periodic Sensing Occasion) in order to perform sensing according to a periodicity for partial sensing operations on the NR SL. K can enable sensing periodicity of a number of slots (e.g., 1 or 2 slots) before the selected candidate resource. Pᵣₑₛₑᵣᵥₑ can be a periodicity correspond to a resource pool configuration (e.g., a periodic Sensing Occasion Reservation Period List), if configured; otherwise, the periodicity can be derived from a sidelink configuration list (e.g., sl-Resource Reserve Period List), for example.

Additionally, or alternatively, the UE 110-1 can perform contiguous partial sensing or CPS for partial sensing of the NR SL resources with a sensing window (or sensing occasions). The time for sensing, or the sensing window, can be represented as: [n+T_{A}, n+T_{B}], where n can be an initial NR slot, T_{A} can be M logical slots before a first selected resource candidate slot (t_{y0}), and T_{B} can be represented as T_{proc,0}+T_{proc,1} processing times in slots before the first selected resource candidate slot t_{y0}. M can be defined by a resource pool configuration (e.g., contiguous Sensing Window Periodic or contiguous Sensing Window Aperiodic) depending on a traffic type (periodic traffic or aperiodic traffic). CPS can be utilized in order to detect an aperiodic sensing resource reservation, where traffic is aperiodic, for example.

In an aspect, full sensing on LTE SL resources can be performed based on the first selected candidate slot t_{y0} utilized in the partial sensing operations for sensing results determined in the NR SL resources. Full sensing in the LTE SL can be modified from the LTE full sensing described above regarding FIG. 8, so that rather than n′ being mapped to the initial NR slot n, full sensing can be based on a first selected candidate slot t_{y0} as used in the NR partial sensing, for example. Therefore, because NR SL partial sensing is performed, LTE full sensing operations can be based on a selected candidate slot in NR SL so that the LTE SL sensing window is configured according to the selected candidate slot t_{y0}. For example, the sensing window for LTE sidelink can be [t′_{y0}−10*Pₛₜₑₚ, t′_{y0}−X], where t′_{y0} is the LTE Logical or physical subframe corresponding to and mapping to the selected candidate slot t_{y0}. As described above, X can be determined by additional processing time X that is factored into the LTE sensing window configuration because involves passing sensing results of candidate resources across different SL modules. The additional processing time X can be larger than 1, for example, 2 ms, 3 ms, 4 ms, or the like, or alternatively be 1. The parameter Pₛₜₑₚ (e.g., 100 ms for FDD, or other time increment) can be dependent on an FDD/TDD configuration or parameter, for example.

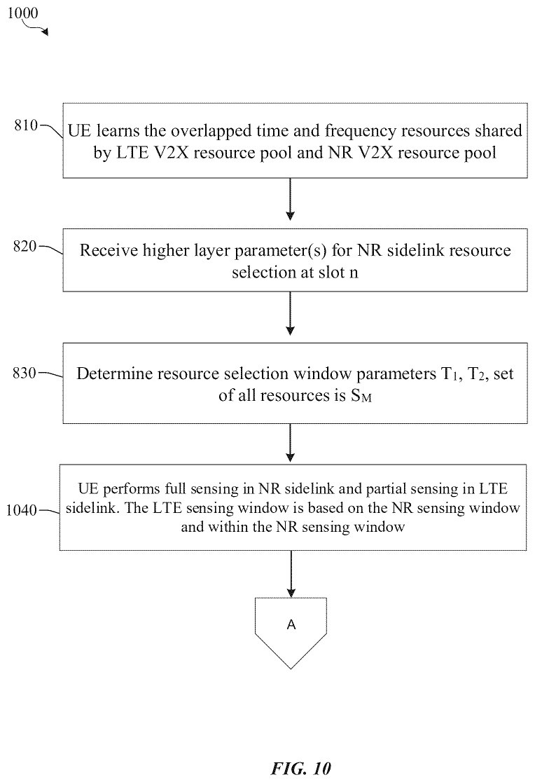

Referring to FIG. 10, illustrated is another example process flow 1000 for resource allocation in co-channel coexistence according to aspects for full sensing in NR SL resources and partial sensing in LTE SL resources. For NR SL resources, full sensing can be performed in a full sensing window period. The process flow 800 can have similar acts 810 thru 830 of FIGS. 8 and 9, and additionally include at 1040 performing full sensing in the NR SL and partial sensing in the LTE SL, in which the sensing occasions (or LTE sensing window) for LTE SL resources are within the full resource selection window for NR SL.

In an aspect, the sensing window for NR SL can be represented as: [n−T₀, n−T_{proc,0}], as described above for FIG. 8 for NR full sensing window configuration. T₀ can be equal to the sl-SensingWindow (pre) configured for an NR sidelink resource pool. Sensing occasions for LTE sidelink can be represented as: t_{y-k*P}_{ₛₜₑₚ}, where t_{y} can be a candidate subframe for LTE sidelink that is within the resource selection window for NR sidelink. K can be 1 or 2 based on a resource pool configuration (e.g., an additional Periodic Sensing Occasion) in order to perform sensing according to a periodicity. K can enable sensing periodicity of a number of slots (e.g., 1 or 2 slots) before the selected candidate resource. The parameter Pₛₜₑₚ (e.g., 100 ms for FDD, or other time increment) can be dependent on an FDD/TDD configuration or parameter, for example.

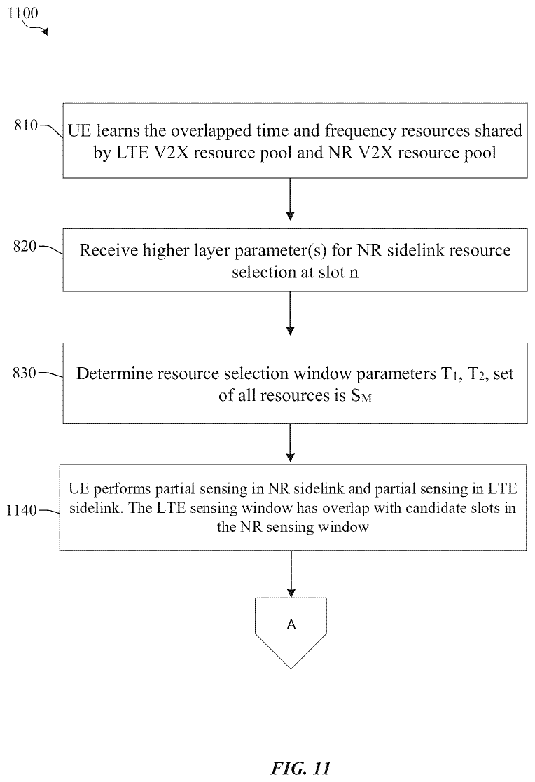

Referring to FIG. 11, illustrated is another example process flow 1100 for resource allocation in co-channel coexistence according to aspects for partial sensing in NR SL resources and partial sensing in LTE SL resources. For NR SL resources, partial sensing can be performed in a partial sensing window period. The process flow 1100 can have similar acts 810 thru 830 of FIGS. 8 thru 10, and additionally include at 1140 performing partial sensing in the NR SL and partial sensing in the LTE SL, in which an LTE sensing window has overlap in time/frequency with a candidate slot in an NR sensing window for NR SL resources.

In an aspect, the sensing occasion at the LTE SL can be based on t_{y-k*P}_{ₛₜₑₚ}, where t_{y} is a selected candidate slot of the NR SL transmission, and K can be 1 or 2 based on a resource pool configuration (e.g., an additional Periodic Sensing Occasion) in order to perform sensing according to a periodicity. For the NR SL, the UE can perform PBPS or CPS as described above with respect to FIG. 9. When UE 110-1 performs PBPS, the UE can monitor slots at t_{y-k*Preserve}, where t_{y} is a selected candidate slot for SL transmission. The UE 110-1 can perform CPS with sensing window [n+T_{A}, n+T_{B}], where T_{A} can be M logical slots before a first selected resource candidate slot (t_{y0}), and T_{B} can be represented as T_{proc,0}+T_{proc,1} processing times in slots before the first selected resource candidate slot t_{y0}. M can be defined by a resource pool configuration (e.g., contiguous Sensing Window Periodic or contiguous Sensing Window Aperiodic) depending on a traffic type (periodic or aperiodic traffic). The sensing occasions of an LTE sensing window for LTE sidelink can be represented as t_{y-k*P}_{ₛₜₑₚ}, where t_{y} is a candidate subframe for LTE sidelink, which has time overlap with any candidate slots in NR sidelink; K can be 1 or 2 based on a resource pool configuration (e.g., an additional Periodic Sensing Occasion) in order to perform sensing according to a periodicity, and Pₛₜₑₚ (e.g., 100 ms for FDD, or other time increment) can be dependent on an FDD/TDD configuration or parameter.

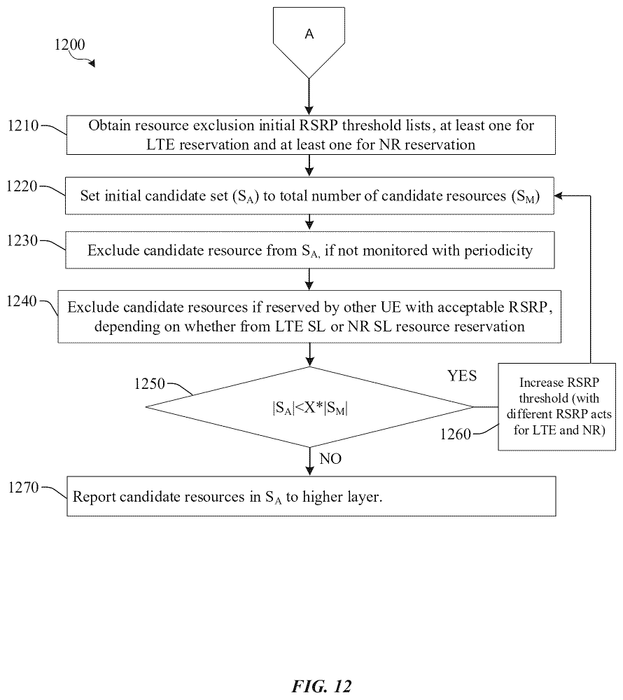

Referring to FIG. 12, illustrated is another example process flow 1200 that can flow from any one or more of FIGS. 8 thru 11 at “A” for resource allocation for SL transmission in co-channel coexistence with LTE SL and NR SL resources in accord with various aspects.

The process flow 1200 continues from “A” of any one or more of FIGS. 8 thru 11, at 1210 by the UE 110-1 obtaining resource exclusion initial RSRP threshold lists (or data sets). At least of one the threshold lists correspond to and comprise RSRPs for LTE reservation of resources and at least one other of the threshold lists correspond to and comprise RSRPs for NR reservation of resources.

In an aspect, the RSRPs selected can depend on a priority of the data transmitted or the data to be received so that different data priorities being transmitted in an SL channel in co-channel coexistence can be associated with different RSRP values of the RSRP lists. An RSRP list can be obtained, pre-configured, or received by a higher layer. For example, two independently (pre) configured initial RSRP threshold lists can be pre-configured corresponding to LTE and NR, respectively.

In one example, an RSRP threshold list can comprise an “sl-Thres-RSRP-List” for NR SL. This RSRP list can serve as the initial RSRP threshold list, with the actual RSRP threshold depending on the transmitting data priority (pᵢ) and NR reservation data priority (pᵢ), where the transmitting data priority (pᵢ) can correspond to other UEs reservation(s) corresponding data priority, and the NR reservation data priority (pⱼ) correspond to the transmitting UE 110-1′s data priority. Thus, UE 110-1 can determine the RSRP from the RSRP threshold list based on data priorities of other SL transmitting data of other UEs and its own SL data being transmitted for the NR SL. For the LTE SL, an additional threshold list (e.g., “sl-Thres-RSRP-LTE-List”) can be used for the sensing on the LTE SL channel. This list can serve as the initial RSRP threshold list for the LTE SL, with the actual RSRP threshold, depending on the transmitting data priority (pᵢ) and LTE reservation data priority (pⱼ). The UE 110-1 further can determine the RSRP threshold from the additional threshold list based on LTE resource reservation(s) Pⱼ, and the transmitting UE 110-1 with the NR SL data for NR SL transmission as Pᵢ. Therefore, the UE 110-1 can utilize independent priority list for an initial RSRP threshold that depends on the LTE SL data priority and the NR SL data priority being transmitted in co-channel coexistence sharing time/frequency resources on an SL channel.

Alternatively, or additionally, a single combined RSRP threshold list can be utilized for determining an RSRP threshold in a resource allocation procedure for SL communication with co-channel coexistence between LTE SL and NR SL. The two lists above (e.g., “sl-Thres-RSRP-List” for NR SL and “sl-Thres-RSRP-LTE-List” for LTE SL) can be correlated to one another so that only one list is used and an offset is (pre) configured to utilize the other. This offset can be an RSRP offset that is an additional parameter configured by, or per, resource pool (e.g., as a single offset value). For example, if UE 110-1 obtains an initial RSRP from the NR SL RSRP threshold list (e.g., “sl-Thres-RSRP-List” for NR SL), then for LTE SL an additional offset can factored into it, such as, for example, an addition or subtraction operation, or other operation to obtain the initial LTE threshold. Thus, the “sl-Thres-RSRP-List” can serve as the initial RSRP threshold list, with the actual RSRP threshold depending on the transmit data priority (pᵢ) of UE 110-1 and any other NR reservation data priority (pⱼ) by other UEs. Then for the transmit data priority (pᵢ) and LTE reservation data priority (pⱼ), the corresponding initial RSRP threshold can be determined by the “sl-Thres-RSRP-List” plus the (pre)configured RSRP offset.

At 1220 and 1230, the process flow 1200 for resource allocation continues similarly as in 630 thru 640 of the process flow 600 of FIG. 6 for performing resource allocation by sensing and selecting available SL resources in co-channel coexistence between NR SL and LTE SL. At 1220, an initial candidate resource set S_{A} can be initialized to include all the resources in the resource selection window. This initial candidate resource set S_{A} can be within the total number of candidate resources Sm. At 1230, the UE 110-1 can exclude candidate resources from the candidate resource set S_{A} that the UE 110-1 does not sense resources in a sensing resource window with configured resource reservation periods before a candidate slot, such as those not monitored in a periodicity.

At 1240, the process flow 1200 continues by excluding candidate resources that are determined to be reserved by other UEs with an RSRP satisfying a threshold according to the data priority for SL transmission on the SL channel if reserved. In an aspect, this exclusion can depend on whether the reservation, or use of the resource, is from the LTE SL or the NR SL resource. For example, LTE SL resource reservations could have a higher priority than the NR SL resource reservations, or vice versa, the NR SL resource reservations have a higher priority than the LTE SL reservations. In the resource selection window, the transmitting UE 110-1 can exclude the candidate resource if it is reserved by another UE with a large enough RSRP measurement, which is larger than the threshold depending on whether the reservation is from LTE SL or NR SL resources. This RSRP can be based on the aspects above at 1230, or an increased RSRP threshold from the initial RSRP threshold (as discussed below with process flow act 1250).

At 1250 a determination is made similar to 660 of FIG. 6, where the UE 11-1 can determine whether the number of resources in the candidate resource set S_{A} is smaller than X*Mₜₒₜₐₗ or X*S_{M}, where X can be a positive integer or percentage of the total number of candidate resources. If the determination is “yes”, then at 160 the UE 110-1 can increase the RSRP threshold (e.g., a 3 dB increase), and repeat 1220 thru 1250 to determine if any of the remaining resources are available, remaining resources are a certain percentage of the total number of resources in another iteration when increasing the RSRP threshold; thereby, giving a less likely chance of to exclude some resources and potentially make the candidate resource set S_{A} larger. Once an X percentage of the total number of resources S_{M} are within the candidate set, then the UE 110-1 can report the candidate results to a higher layer for a random resource selection. In other words, if “no” is the determination at 1270, then the UE 110-1 can report the candidate resource set S_{A} to a higher layer.

In an aspect, at 1260 an increase can be based on an increment of 3 dB for at least one of: NR SL or LTE SL; thus, the 3 dB could be applied to one or both. Alternatively, or additionally, the 3 dB increase could be applied to an RSRP threshold for only the NR SL, and another different incremental increase (e.g., 5 dB) be applied to for LTE SL.

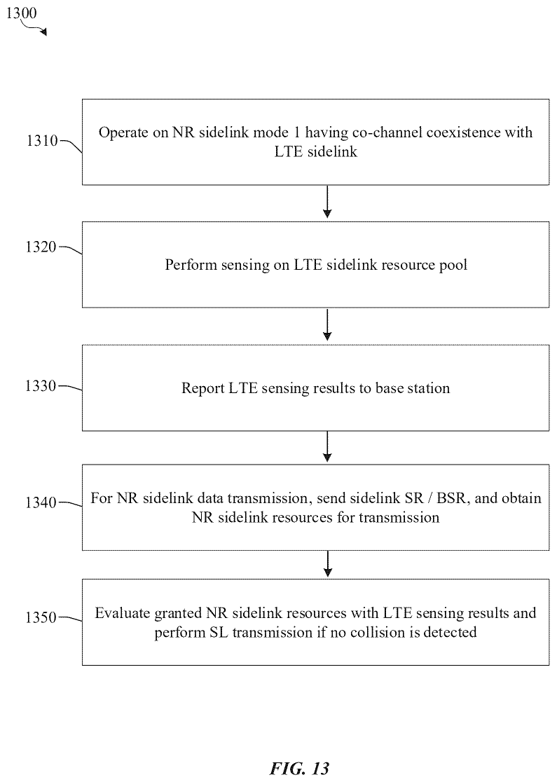

Referring to FIG. 13, illustrated is an example process flow 1300 for resource allocation for SL transmission in co-channel coexistence with LTE SL and NR SL resources in accord with various aspects. Process flow 1300 by UE 110-1 can support the NR SL being in mode-1 SL operation and the LTE SL be in mode-4 operation; thus, the NR SL UE can report the LTE sensing results to the base station.

At 1310, the UE 110-1 can operate on the NR SL in mode-1 operation and the LTE SL in mode-4 operation, for example, in co-channel coexistence between LTE SL and NR.

At 1320, the UE 110-1 can perform resource sensing on the LTE SL without performing sensing on the NR SL resources because the NR SL transmission resources are allocated by the base station or gNB 120, for example. Although the UE 110-1 configures operation for SL resource allocation, SL sensing and SL transmission co-channel coexistence between LTE SL and NR SL, in mode-1 the UE 110-1 acquires its NR SL resources from the base station, and performs its own resource allocation and sensing from only the candidates of the LTE SL because the LTE SL resources are configured in a mode-4 LTE SL resource allocation.

At 1330, the UE 110-1 still operates to report its LTE sensing results even though resource allocation for SL transmission is being configured in co-channel coexistence between NR SL and LTE SL. The UE 110-1 reports its sensing result(s) on a same co-channel so the base station or gNB 120 can obtain information about LTE resource usage by which it can take into account when scheduling NR resources for NR SL resource allocation for UE 110-1, as well as for other UEs in proximity thereto or in the same network.

In an aspect, the UE 110-1 can report its LTE sensing results to the base station in response to a trigger or trigger condition. For example, a trigger condition could be a request received from the base station or gNB 120, as the gNB 120 may know that UE 110-1 performed sensing on the LTE SL and further provide a request to the UE 110-1 to provide some sensing results for LTE SL.

Alternatively, or additionally, the reporting could be event triggered. For example, if UE 110-1 has some NR SL data to transmit, it may ask for an NR SL grant from gNB 120 and at that time report its LTE sensing results to gNB 120.

Alternatively, or additionally, the reporting could depend on LTE channel busy ratio (CBR). For example, if the LTE SL channel is busy, or exceeds a CBR threshold, then the UE 110-1 can be triggered to report sensing results to gNB 120, further indicating by the report that there is a lot of resource usage from LTE SL and caution may be warranted to not collide with other LTE SL transmissions.

In an aspect, the reporting frequency of sensing results could be aperiodic or periodic. Reporting could be configured according to a periodic pattern or sporadically, for example, in an aperiodic patter, for example.

In aspect, the reporting format could take the format of a resource map such as in a two dimensional time and frequency dimensional resource map. Alternatively, or additionally, the reporting format could be indicated as in time domain resource indicator value (TRIV), a frequency resource indicated value (FRIV), and based on a periodicity or a priority of the resources.

At 1340, the NR SL data transmission UE can send a scheduling request (SR) report and a buffer status report (BSR) to the base station in order to then obtain the NR SL resources for NR SL transmission. For the NR SL data transmission, the UE 110-1 could first ask for an SL grant from gNB 120, but additionally it may check granted resource from the gNB to determine whether the gNB 120 stills grants resources that have some collision with LTE sensing result(s) that gNB has not been reported to, which may happen due to LTE sensing results not being reported in time.

At 1350, the UE 110-1 can obtain the SL transmission grant from the base station or gNB 120 on this particular SL channel. The UE 110-1 can additionally check if the granted NR SL resource has potential collision, such as with updated LTE SL results. If no collision potential is detected, the UE 110-1 can perform the NR SL transmission; otherwise it may drop the transmission or take additional/repeated actions as described here.

In aspect, if UE 110-1 determines that there is a potential collision between the NR sidelink grant and any LTE sidelink reservation, the UE 110-1 may not transmit on the granted NR sidelink resources, and may report a sidelink hybrid automatic repeat request negative-acknowledgment (SL HARQ-NACK) to the gNB 120 to indicate a failure to SL transmit. Alternatively, or additionally, the UE 110-1 can use the scheduled grant and ignore LTE occupancy. Alternatively, or additionally, UE 110-1 can compare an LTE SL priority associated with the reservation or resource of potential collision with an NR SL data priority for which it is attempting to SL transmit. For example, if UE 110-1 has its own NR SL data to transmit may be a higher priority than the LTE SL priority of the resource with potential collision. If the LTE SL has higher priority, then the UE 110-1 could drop NR grant. If it is reserved by another UE with a lower data priority, then the UE 110-1 could continue to transmit. However, if the LTE SL is reserved with a higher priority data, and UE 110-1 has its own NR SL transmission with a lower priority data, then it could drop the NR grant. If there is no collision, then UE 110-1 can transit on the granted NR sidelink resources.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The present disclosure will now be described with reference to the attached drawing figures, wherein like reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), or firmware. For example, a component can be a processor (e.g., a microprocessor, a controller, or other processing device), a process running on a processor, a controller, an object, an executable, a program, a storage device, a computer, a tablet PC or a user equipment (e.g., mobile phone, etc.) with a processing device. By way of illustration, an application running on a server and the server can also be a component. One or more components can reside within a process, and a component can be localized on one computer or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local or remote processes such as in accordance with a signal having one or more data packets (e.g., data from one component interacting with another component in a local system, distributed system, or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

As used herein, the term “circuitry” can refer to, be part of, or include an Application Specific Integrated Circuit (ASIC), an electronic circuit, a processor (shared, dedicated, or group), or associated memory (shared, dedicated, or group) operably coupled to the circuitry that execute one or more software or firmware programs, a combinational logic circuit, or other suitable hardware components that provide the described functionality. In some embodiments, the circuitry can be implemented in, or functions associated with the circuitry can be implemented by, one or more software or firmware modules. In some embodiments, circuitry can include logic, at least partially operable in hardware.

As it is employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions or processes described herein. Processors can exploit nano-scale architectures such as, but not limited to, molecular and quantum-dot based transistors, switches and gates, in order to optimize space usage or enhance performance of mobile devices. A processor can also be implemented as a combination of computing processing units.

Examples (embodiments) can include subject matter such as a method, means for performing acts or blocks of the method, at least one machine-readable medium including instructions that, when performed by a machine (e.g., a processor with memory, an application-specific integrated circuit (ASIC), a field programmable gate array (FPGA), or the like) cause the machine to perform acts of the method or of an apparatus or system for concurrent communication using multiple communication technologies according to embodiments and examples described herein.

Moreover, various aspects or features described herein can be implemented as a method, apparatus, or article of manufacture using standard programming or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices or other machine-readable media for storing information. The term “machine-readable medium” can include, without being limited to, wireless channels and various other media capable of storing, containing, or carrying instruction(s) or data. Additionally, a computer program product can include a computer readable medium having one or more instructions or codes operable to cause a computer to perform functions described herein.

Communications media embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

An exemplary storage medium can be coupled to processor, such that processor can read information from, and write information to, storage medium. In the alternative, storage medium can be integral to processor. Further, in some aspects, processor and storage medium can reside in an ASIC. Additionally, ASIC can reside in a user terminal. In the alternative, processor and storage medium can reside as discrete components in a user terminal. Additionally, in some aspects, the processes or actions of a method or algorithm can reside as one or any combination or set of codes or instructions on a machine-readable medium or computer readable medium, which can be incorporated into a computer program product.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In particular regard to the various functions performed by the above described components (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the disclosure. In addition, while a particular feature can have been disclosed with respect to only one of several implementations, such feature can be combined with one or more other features of the other implementations as can be desired and advantageous for any given or particular application.

1-20. (canceled)

21. A user equipment (UE), comprising:
radio frequency (RF) circuitry;
a memory; and
processing circuitry coupled to the RF circuitry and the memory, the processing circuitry configured to execute instructions stored in the memory to cause the UE to:
perform sensing of candidate resources on a Long Term Evolution (LTE) sidelink (SL) resource pool of an LTE SL channel and a new radio (NR) SL resource pool of an NR SL channel; and
transmit, via the RF circuitry, a SL communication on the NR SL channel based on the sensing of the candidate resources on the LTE SL resource pool and the NR SL resource pool.

22. The UE of claim 21, wherein the processing circuitry further causes the UE to:
perform resource selection of the candidate resources on the NR SL resource pool based on the sensing of the LTE SL resource pool, wherein the LTE SL resource pool overlaps in time and frequency with the NR SL resource pool.

23. The UE of claim 21, wherein the processing circuitry further causes the UE to:
perform a SL resource selection procedure for the SL communication on the NR SL channel based on a higher priority of the LTE SL resource pool relative to the NR SL resource pool.

24. The UE of claim 21, wherein the processing circuitry further causes the UE to:
perform the sensing of the candidate resources on the LTE SL resource pool of the LTE SL channel during an LTE sensing window and on the NR SL resource pool of the NR SL channel during an NR sensing window;
wherein the NR SL channel is in co-channel coexistence with the LTE SL channel;
wherein the LTE sensing window is configured for a full sensing operation or a partial sensing operation on the LTE SL channel; and
wherein the NR sensing window is configured for the full sensing operation or the partial sensing operation on the NR SL channel.

25. The UE of claim 21, wherein the processing circuitry further causes the UE to:
perform a full sensing operation on the NR SL channel during an NR sensing window and a full sensing operation on the LTE SL channel during an LTE sensing window, based on overlapping time and frequency resources between the LTE SL resource pool and the NR SL resource pool.

26. The UE of claim 25, wherein the NR sensing window is based on an initial NR slot (n) that triggers an NR SL resource selection procedure, a SL-sensing window parameter of one or more slots that is preconfigured or indicated by a higher layer signaling, and a processing time (T_{proc,0}) of the sensing, wherein n comprises an integer, and wherein the LTE sensing window is based on an LTE logical or physical subframe (n′) that corresponds to the initial NR slot (n), a frequency division duplexing (FDD)/time division duplexing (TDD) configuration parameter, and a predefined positive integer or an in-device coordination time between an LTE SL module component and an NR SL module component.

27. The UE of claim 21, wherein the processing circuitry further causes the UE to:
perform a partial sensing operation on the NR SL channel during an NR sensing window and a full sensing operation on the LTE SL channel during an LTE sensing window based on overlapping time and frequency resources between the LTE SL resource pool and the NR SL resource pool, wherein the LTE sensing window is based on a first selected candidate slot from the partial sensing operation on the NR SL channel, and wherein the NR SL channel is in co-channel coexistence with the LTE SL channel.

28. The UE of claim 21, wherein the processing circuitry further causes the UE to:
perform a full sensing operation on the NR SL channel during an NR sensing window and a partial sensing operation on the LTE SL channel during an LTE sensing window based on overlapping time and frequency resources between the LTE SL resource pool and the NR SL resource pool, wherein a candidate subframe of the LTE SL channel is within the NR sensing window for the NR SL channel, and wherein the NR SL channel is in co-channel coexistence with the LTE SL channel.

29. A baseband processor configured to, when executing instructions stored in a memory, perform operations comprising:
perform sensing of candidate resources on a Long Term Evolution (LTE) sidelink (SL) resource pool of an LTE SL channel and a new radio (NR) SL resource pool of an NR SL channel; and
provide, to a radio frequency (RF) interface for transmission, a SL communication on the NR SL channel based on the sensing of the candidate resources on the LTE SL resource pool and the NR SL resource pool.

30. The baseband processor of claim 29, wherein the operations further comprise:
performing a partial sensing operation on the NR SL channel during an NR sensing window and another partial sensing operation on the LTE SL channel during an LTE sensing window based on overlapping time and frequency resources between the LTE SL resource pool and the NR SL resource pool;
wherein a candidate subframe of the LTE SL channel overlaps in time with a candidate slot in the NR SL channel, and wherein the NR SL channel is in co-channel coexistence with the LTE SL channel.

31. The baseband processor of claim 29, wherein the operations further comprise:
determining an initial reference signal received power (RSRP) for excluding candidate resources based on two separate RSRP threshold lists;
wherein the two separate RSRP threshold lists comprise a first RSRP threshold list for NR reservation of candidate resources and a second RSRP threshold list for LTE reservation of candidate resources.

32. The baseband processor of claim 29, wherein the operations further comprise:
excluding candidate resources reserved by other user equipments (UEs) with a reference signal received power (RSRP) threshold based on whether a reservation is on the LTE SL channel or the NR SL channel.

33. The baseband processor of claim 29, wherein the operations further comprise:
in response to selected candidate resources being less than a percentage of total available candidate resources, increasing a reference signal received power (RSRP) threshold with a same increase for both LTE SL candidate resources and NR SL candidate resources.

34. The baseband processor of claim 29, wherein results of the sensing comprise LTE SL mode-4 sensing results and NR SL mode-2 sensing results, or only comprise the LTE SL mode-4 sensing results when operating in NR SL mode-1 in co-channel coexistence with the LTE SL channel and the operations further comprise reporting the LTE SL mode-4 sensing results to a base station to obtain an NR scheduling grant for the SL communication based on the LTE SL mode-4 sensing results.

35. The baseband processor of claim 34, wherein the operations further comprise:
determining that a potential collision exists between NR SL resources of the NR scheduling grant and an LTE SL reservation; and
in response to the determination, dropping the NR scheduling grant and reporting a sidelink hybrid automatic repeat request negative acknowledgment (SL-HARQ NACK), or using the NR scheduling grant based on a higher NR SL priority of the NR scheduling grant relative to a LTE SL priority of the LTE SL reservation.

36. A method for a user equipment (UE), comprising:
performing, via processing circuitry, sensing of candidate resources on a Long Term Evolution (LTE) sidelink (SL) resource pool of an LTE SL channel and a new radio (NR) resource pool of an NR SL channel; and
transmitting, via radio frequency (RF) circuitry, a SL communication on the NR SL channel based on the sensing of the candidate resources on the LTE SL channel and the NR SL resource pool.

37. The method of claim 36, further comprising:
determining overlapping time and frequency resources shared by the LTE SL resource pool and the NR SL resource pool;
receiving parameters for an NR resource selection at a slot; and
determining resource selection window parameters based on a total number of candidate resources.

38. The method of claim 37, further comprising:
configuring an NR sensing window for the NR SL channel and an LTE sensing window for the LTE SL channel, based on LTE sensing in a full sensing operation or a partial sensing operation of the LTE sidelink channel and the NR sensing window in the full sensing operation or the partial sensing operation of the NR sidelink channel.

39. The method of claim 37, further comprising:
obtaining one or more initial reference signal received power (RSRP) threshold lists comprising at least one of: an LTE reservation list or an NR reservation list;
excluding candidate resources according to at least one of: the one or more initial RSRP thresholds or an RSRP offset value associated with the at least one of: the LTE reservations list or the NR reservation list and a priority of the LTE SL resource pool and the NR SL resource pool; and
in response to selected candidate resources being less than a percentage of total available candidate resources, increasing the one or more initial RSRP thresholds differently for LTE SL candidate resources than NR SL candidate resources, or with a same increase for both the LTE SL candidate resources and the NR SL candidate resources.

40. The method of claim 37, further comprising:
determining that a number of candidate LTE resources is less than a first threshold value and a number of candidate NR resources is less than a second threshold value; and
in response to the determination, incrementing an RSRP value associated with the candidate LTE resources by an increment value, and incrementing an RSRP value associated with the candidate NR resources by the increment value.
